(19) United States
(12) Patent Application Publication
(10) Pub. No.: US 2016/0108855 A1
(43) Pub. Date: Apr. 21, 2016

(54) DUAL MODE CHEMICAL ROCKET ENGINE, AND DUAL MODE PROPULSION SYSTEM COMPRISING THE ROCKET ENGINE

(71) Applicant: ECAPS AB, Solna (SE)

(72) Inventors: Kjell Anflo, Haninge (SE); Göran Bergman, Nykvarn (SE)

(21) Appl. No.: 14/892,621

(22) PCT Filed: May 28, 2014
(86) PCT No.: PCT/SE2014/050656

§ 371 Date: Nov. 20, 2015

(30) Foreign Application Priority Data
May 29, 2013 (SE) 1350653-0

(51) Int. Cl. F02K 9/42; F02K 9/60; F02K 9/62; F02K 9/52

(52) U.S. Cl. CPC F02K 9/425; F02K 9/52; F02K 9/605; F02K 9/62; F05D 2220/80; F05D 2210/11; F05D 2240/35

(57) ABSTRACT

The invention relates generally to dual mode bipropellant chemical rocket propulsion systems to be used in aerospace applications for 1) orbit raising, orbit manoeuvres and maintenance, attitude control and deorbiting of spacecraft, and/or 2) propellant settling, attitude and roll control of missiles, launchers and space planes. The present invention also relates to a dual mode chemical rocket engine for use in such systems. The engine uses low-hazardous storable liquid propellants and can be operated either in monopropellant mode or in bipropellant mode. The monopropellants used are a low-hazard liquid fuel-rich monopropellant, and hydrogen peroxide, respectively.

### FIELD OF THE INVENTION

The subject invention relates generally to dual mode bipropellant chemical rocket propulsion systems to be used in aerospace applications for 1) orbit raising, orbit manoeuvres and maintenance, attitude control and deorbiting of spacecraft, and/or 2) propellant settling, attitude and roll control of missiles, launchers and space planes. The present invention also relates to a dual mode chemical rocket engine for use in such systems. The engine uses low-hazardous storable liquid monopropellants compared to the current state of the art and can be operated either in monopropellant mode or in bipropellant mode. The monopropellants used are a low-hazard liquid fuel-rich monopropellant, and hydrogen peroxide, respectively.

### BACKGROUND OF THE INVENTION

Dual mode rocket propulsion systems and dual mode rocket engines (also referred to as thrusters) are known in the art. Currently, many spacecraft use dual-mode propulsion systems, with bipropellant engines for larger thrust operations, and monopropellant engines for smaller thrust or when minimum impulse bit is important. In the art the choice of propellants which are suitable in both bipropellant and monopropellant engines are limited to a few very hazardous propellants. Such bipropellants comprise hydrazine or a derivative thereof, such as monomethyl hydrazine (MMH) and unsymmetrical dimethyl hydrazine (UDMH). An example of a dual mode thruster is a thruster referred to as a Secondary Combustion Augmented Thruster (SCAT). A bipropellant dual mode rocket propulsion system comprising a bipropellant thruster having dual mode capability (i.e. ability to operate either in monopropellant mode or in bipropellant mode) has been described in e.g. U.S. Pat. No. 6,135,393, wherein hydrazine is used as the fuel, and, preferably, nitrogen tetroxide (NTO) as the oxidizer.

The mission requirements for a particular propulsion system requiring high performance are defined by a set of figures of merit. One of the most important figures of merit is specific impulse (Iₛₚ) as it indicates the maximum velocity changes that the spacecraft can achieve, which is the very objective of such propulsion system. Specific impulse is defined as the thrust developed by an engine per unit of propellant mass flow rate. If the thrust is measured in Newton (N) and the flow rate is measured in kilograms (kg) per second (s), then the unit of measurement of specific impulse is Ns/kg. For medium to large spacecraft with requirements of significant velocity changes this is the most important parameter. For small spacecraft where dimensions may be limiting, the density impulse, i.e. Ns per propellant volume, may be the dominant figure of merit. Another figure of merit is the thrust of a rocket engine as it determines how long a maneuver will take and what acceleration it will provide. Yet another parameter is the smallest or minimum impulse bit (Ns) that the engine can generate as it determines how precise a maneuver can be performed.

Both hydrazine (fuel) and nitrogen tetroxide (oxidizer), and their derivatives are extremely hazardous for humans as they are highly toxic, carcinogenic, corrosive, etc., and they are associated with significant concerns regarding the severe impact on the environment that they can cause in the case of spillage and emissions. Therefore the handling thereof and the safety requirements are extremely demanding, time consuming and costly.

The ECHA (European Chemicals Agency) has within REACH (Registration, Evaluation, Authorisation and restriction of Chemicals), which is the European Community Regulation on chemicals and their safe use, identified hydrazine as a substance of very high concern which may lead to that hydrazine may be banned for use in new development. Clean Space, which is an initiative by the European Space Agency (ESA), also calls for substituting conventional hazardous propellants.

There is also a new law, Space Operations Act, in France, with respect to space debris, which requires that the spacecraft shall be deorbited when no longer in use.

Accordingly, it is therefore desirable to provide a dual mode propulsion system avoiding the use of hydrazine, nitrogen tetroxide, and derivatives thereof However, so far, no viable rocket propulsion systems, rocket engines, and corresponding alternative propellants with performance comparable to the prior art hazardous hydrazine propellants have been realized.

### SUMMARY OF THE INVENTION

The present inventors have found that a propulsion system with comparable performance (i.e. in terms of total impulse for a given system mass) to the prior art dual mode chemical propulsion systems can be achieved by a dual mode chemical rocket engine using storable low-hazardous liquid propellants.

According to the invention a fuel-rich monopropellant, and hydrogen peroxide, respectively, are used in a dual mode rocket engine comprising primary and secondary reaction chambers.

Accordingly, in one aspect the invention relates to a dual mode chemical rocket engine having a primary reaction chamber for hydrogen peroxide connected to a secondary reaction chamber having means for injection therein of a fuel-rich monopropellant.

In monopropellant mode operation, the inventive engine uses hydrogen peroxide, which is catalytically decomposed in the primary reactor. Operation and start of the inventive engine in monopropellant mode does not require any pre-heating of the primary reactor, such as by means of an electrical heater.

In bipropellant mode, the catalytic combustion of hydrogen peroxide, taking place in the primary reactor, is used to provide an oxidizer and heat to initiate the thermal decomposition of a liquid ADN or HAN based fuel-rich monopropellant in the secondary reactor, which fuel-rich monopropellant is injected into the secondary reactor. Operation of the inventive engine in bipropellant mode has the advantage of increasing the thrust and specific impulse of the thruster as compared to when operated in monopropellant mode. Operation and start of the inventive engine in bipropellant mode does also not require any electrical preheating of the engine or reactors.

The inventive dual mode chemical rocket engine can thus be made so as to not comprise an electrical heater.

In one embodiment of the inventive engine the means for injection enables injection of the fuel-rich monopropellant from a propellant feed line from outside into the secondary reaction chamber.

In another aspect the invention relates to a dual mode propulsion system comprising the inventive dual mode chemical rocket engine.

By means of the present invention, a unified propulsion system (UPS) based on “green” alternative monopropellants can be achieved, such as e.g. based on the HPGP® technology, i.e. a system wherein all engines are capable of being operated on one and the same monopropellant. Such a system can include small monopropellant thrusters together with larger dual mode thrusters connected to the same propellant feed system.

The invention uses high performance, low-hazard and environmental benign alternative propellants and has the potential to achieve substantial time and cost savings as compared to the prior art dual mode rocket engines and propulsion systems.

A major advantage of the invention is that existing and well proven catalysts and catalyst beds currently used for the respective monopropellants can also be used with the present invention. The primary catalytic reactor specific to hydrogen peroxide does therefore not require any modification.

In a preferred embodiment of the invention LMP-1035 (disclosed e.g. in WO 2012/166046) is used as the fuel-rich monopropellant. Thrusters operated with LMP-103S has during hot firing tests on ground and in-space firings demonstrated an improved specific impulse with >6%, and an improved density impulse with >30%, as compared to hydrazine (monopropellant).

In yet an aspect the present invention relates to a method of generating thrust, wherein a fuel-rich liquid monopropellant is injected into a flow of hot oxidizer-rich gas obtained from the decomposition of hydrogen peroxide, so that the fuel-rich liquid monopropellant thereby is decomposed and combusted along with the oxidizer-rich gas.

The invention provides an enabling technology for substituting the conventional dual mode and bipropellant rocket propulsion systems using highly hazardous storable liquid propellants with a significantly reduced hazard and environmentally benign alternative propellants system with comparable performance, and which also will significantly reduce and facilitate propellant handling and fuelling operations.

Further advantages and embodiments will be apparent from the following detailed description and appended claims.

In the present invention the term “monopropellant” has been used to denote both monopropellants which are composed of more than one chemical compound, such as LMP-103S, which thus could be regarded a monopropellant blend, and also to denote single compound monopropellants, such as H₂O₂ (which in practice however typically will be aqueous, and thus will also include some water).

The term “propulsion system” is used herein to denote the hydraulic architecture of the hardware and its components for the purpose of generating propulsive thrust of a spacecraft, launcher attitude control system etc., comprising propellant tank(s), pressurant tank(s), propellant and pressurant loading service valves, propellant and pressurant lines, isolation valve(s), propellant system filter(s), pressure transducer(s), thrusters/rocket engines and other mission specific fluid components required. Such system is schematically illustrated in FIG. 1.

### BRIEF DESCRIPTION OF THE ATTACHED DRAWINGS

FIG. 1 is a simplified hydraulic schematic representation of an embodiment of the inventive dual mode propulsion system.

FIG. 2 shows an embodiment 100 of the inventive dual mode chemical rocket engine comprising a primary reaction chamber 140, a secondary reaction chamber 150, injection means 125 for injection of a fuel-rich monopropellant, and a high temperature resistant catalytic device 135.

### DETAILED DESCRIPTION OF THE INVENTION AND PREFERRED EMBODIMENTS THEREOF

According to the invention liquid storable low-hazard liquid monopropellants are used. The monopropellants used in the engine of the invention are a fuel-rich monopropellant, and hydrogen peroxide, respectively.

The inventive engine constitutes new propulsion technology enabling the use of low-hazard propellants in dual mode or bipropellant operation.

A significant achievement in the art is the feasibility to substitute hydrazine as a monopropellant for many space applications. This has been successfully demonstrated using the HPGP® technology comprising the LMP-103S monopropellant blend (described in e.g. WO 2012/166046) and corresponding thrusters (disclosed in e.g. WO 02/095207) ranging from typically 0.5 N to 200 N. A 1 N HPGP® propulsion system has been operational for several years in an earth orbit in space on the main PRISMA satellite.

The inventive engine comprises a primary hydrogen peroxide reaction chamber 140 for the decomposition of hydrogen peroxide comprising a catalyst bed for the decomposition of hydrogen peroxide, which primary reaction chamber is connected to, and opens into, a secondary reaction chamber 150 having means 125 for injection therein of a fuel-rich monopropellant.

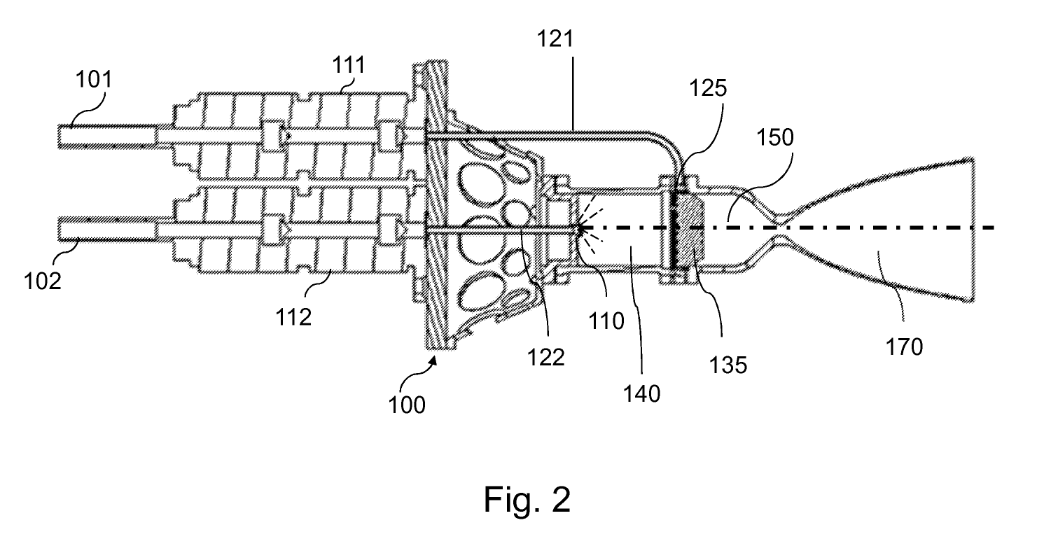

Bipropellant mode operation of the inventive engine can use homogeneous gas phase combustion in the secondary reaction chamber. Alternatively, combustion could be promoted by catalysis using a high temperature resistant catalytic device. In such embodiment the inventive engine additionally comprises a high temperature resistant catalytic device 135, e.g. as shown in FIG. 2.

In one embodiment of the inventive dual mode chemical engine the fuel-rich monopropellant is injected from outside into the secondary reaction chamber of the engine. An example of such embodiment is depicted in FIG. 2.

The catalyst in the primary reaction chamber 140 would be the life limiting element of the thruster when exposed to the reactive decomposition and combustion species and operated at higher temperatures than their current design limits. A major benefit of the invention is that the temperature in the secondary reaction chamber 150 can be significantly increased, while the temperature of the catalyst in the primary reactor can be kept essentially unaffected. Accordingly, existing and well proven catalysts and catalyst beds currently used for hydrogen peroxide can also be used with the present invention. The primary reactor specific to hydrogen peroxide, does therefore not require any modification.

The primary reaction chamber 140 preferably uses conventional technology for the decomposition of hydrogen peroxide.

While fuel-rich monopropellant blends could be based on HAN for the purpose of the present invention, it is generally preferred that the fuel-rich monopropellant blends be based on ADN, unless indicated otherwise.

Preferably, a liquid, aqueous ADN based monopropellant is used as the fuel-rich monopropellant. Such monopropellants have been generally disclosed in WO 00/50363 and WO 2002/096832. Examples of specific compositions are e.g. LMP-101, LMP-103, LMP-1035, and FLP-106, especially LMP-103S which has been described in WO 2012/166046.

According to calculations performed with NASA-Glenn Chemical Equilibrium Program CEA2, operation of the inventive rocket engine in bipropellant mode using the environmentally benign monopropellant LMP-103S would result in an additional improvement of the specific impulse of up to 20% over LMP-103S when used as a monopropellant only, which is comparable with the specific impulse of the prior art bipropellant engines operated on the highly hazardous conventional storable propellants, i.e. MMH and NTO. Furthermore, the density impulse of the LMP-103S and H₂O₂ monopropellant combination will exceed the density impulse of the prior art bipropellant engine operated on conventional storable propellants with up to 5%.

Hydrogen peroxide is probably the most studied monopropellant worldwide. However, the specific impulse of hydrogen peroxide as a monopropellant is relatively low and depending on the concentration it is in the range of 1,600-1,800 Ns/kg. The relatively low specific impulse and concerns about hydrogen peroxide's storability has displaced it from the spacecraft reaction control system (RCS) in favour of hydrazine. Hydrogen peroxide can also be used as an oxidizer in bi-propellant mode and it has been studied for propulsion purposes at least since 1934. Hydrogen peroxide is reactive and decomposes slowly over time when stored even in its most stabilized form. The concerns for the storability and the safe use of hydrogen peroxide have been debated over the years. It is reported that these concerns might be exaggerated and that hydrogen peroxide can be handled safely. However, the toxicological and carcinogenic concerns of the current state-of-the-art propellants have led to renewed interest in hydrogen peroxide during the last 10 years.

The H₂O₂ monopropellant is preferably of a concentration of at least 80%, and more preferably at least 90%. Conventional grades and concentrations of the H₂O₂ monopropellant for rocket propulsion can thus be used in the present invention.

With reference to FIG. 2, a preferred embodiment of the inventive rocket engine 100 will now be described in more detail. In such embodiment the rocket engine comprises an inlet port 102 for the hydrogen peroxide followed by a series redundant flow control valve 112 and propellant feed tube 122, and an inlet port 101 for fuel-rich monopropellant followed by a series redundant flow control valve 111 and propellant feed tube 121 leading into secondary reaction chamber 150.

The engine 100 and operation thereof will now be described in more detail. In bipropellant mode hydrogen peroxide is injected via injector 110 into the primary reaction chamber 140, where the monopropellant is catalytically decomposed causing an exothermal reaction which produces heat (up to 900° C. for 90% H₂O₂) and oxidizer-rich water vapour which flows into the secondary reaction chamber 150. A fuel-rich monopropellant, such as LMP-103S, is injected via injector 125 into the secondary reaction chamber 150, where the fuel-rich mono-propellant is atomized, and is mixed and combusted with the oxygen from the primary reactor in homogeneous gas phase. Thereby, the stagnation gas temperature is further significantly increased (up to 2,300° C.) which enhances the performance of the engine in terms of fuel efficiency, i.e. specific impulse, before the exhaust gases are accelerated through the nozzle 170 thus generating thrust.

The inventive rocket engine 100 can also operate in monopropellant mode for lower thrust and impulse bit by injection of only the hydrogen peroxide, e.g. highly concentrated (≧90%) hydrogen peroxide, which is injected into the primary reaction chamber 140 where the mono-propellant is catalytically decomposed causing an exothermal reaction which produces heat and gas which flows to the secondary reaction chamber 150, before the exhaust gases are accelerated through the nozzle 170 thus generating thrust.

The primary and secondary reaction chambers 140 and 150, respectively, are arranged in series to each other, e.g. as shown in FIG. 2.

Fuel-rich HAN-based monopropellant blends could be used in the same way as LMP-103S.

The secondary combustion chamber 150 of the inventive engine is preferable fabricated from rhenium lined with iridium to withstand the very high combustion temperatures.

The Inventive Propulsion System

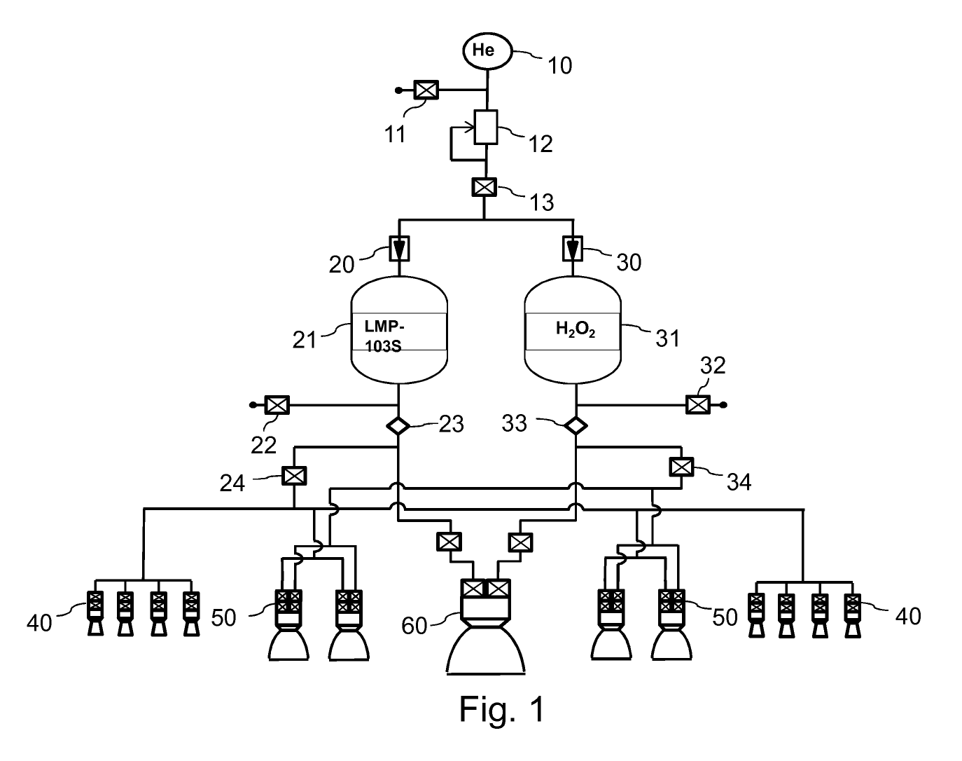

A simplified hydraulic schematic view of an embodiment of the inventive dual mode propulsion system is shown in FIG. 1. Service valves 22 and 32 are used to load the monopropellants into propulsion system prior to operation. The fuel-rich monopropellant, e.g. LMP-103S, is contained in the propellant tank 21, and the hydrogen peroxide is stored in the propellant tank 31. A high pressure (i.e. of several hundred bars) pressurizing gas, e.g. helium, is filled into the pressurant tank 10 via service valve 11 prior to operation of the propulsion system. The propulsion system is commissioned by venting the blanking gas in the propellant lines downstream of the isolation valves 24 and 34, thereafter performing priming of propellant to the thrusters prior to first firing. When firing any thruster the pressurant gas from the tank 10 is regulated down to the rocket engines operating propellant feed pressure (i.e. tens of bars) by a pressure regulator 12. The pressurant flows through the pressurant isolation valve 13 and further through the one-way valves 20 and 30 to the propellant tanks 21 and 31. Depending on the operational modes, i.e. mono- or bipropellant mode, the monopropellant from either of propellant tanks 21 or 31, or both, flow through the respective propellant filters 23 and 33 to the subject engine(s) when firing.

The bipropellant Liquid Apogee Engine (LAE) 60 has an assessed thrust level between 50 N and 10 kN. In an inventive propulsion system, a bipropellant liquid apogee engine 60, when present, is preferably a dual mode engine of the invention.

The divert dual mode thrusters 50 have an assessed thrust level between 5 N and 5 kN. In an inventive propulsion system, a divert dual mode thruster 50, when present, is preferably a dual mode engine of the invention, such as the engine 100.

Any monopropellant rocket engines in the inventive dual mode propulsion system preferably use a liquid, fuel-rich monopropellant, such as an ADN or HAN based monopropellant.

The RCS thrusters 40 are preferable ECAPS 1 N to 22 N HPGP monopropellant thrusters operated on LMP-103S.

In a dual mode propulsion system of the invention, the inventive engine concept is preferably applied to engines which are used early in the mission.

Pre-heating of the primary reactor is neither required in monopropellant mode, nor in bipropellant mode operation of the inventive engine. No electrical pre-heating of either of the reactors is required for the operation of the inventive engine in bipropellant mode. This will greatly reduce the requirements of any heating system included in an inventive propulsion system, and the heating power required by the propulsion system.

The inventive engine accordingly allows for a simplified engine design to be used, without any heater.

1. A dual mode chemical rocket engine (100) having a primary reaction chamber (140) for hydrogen peroxide comprising a catalyst bed for hydrogen peroxide, which primary reaction chamber is connected to a secondary reaction chamber (150) having means for injection (125) therein of a fuel-rich monopropellant, characterized in that the fuel-rich monopropellant is a liquid ADN based, or HAN based monopropellant.

2. The dual mode chemical rocket engine of claim 1, wherein the means for injection (125) is configured to enable injection of the fuel-rich monopropellant from a propellant feed line (121) from outside into the secondary reaction chamber (150).

3. The dual mode chemical rocket engine of 1, additionally comprising in the secondary reaction chamber (150) a high temperature resistant catalytic device (135).

4. The dual mode chemical rocket engine of claim 1, wherein the secondary reaction chamber (150) is fabricated from rhenium.

5. A dual mode propulsion system comprising the dual mode chemical rocket engine (100) of claim 1.

6. The dual mode propulsion system of claim 5, comprising a liquid storable low-hazard fuel-rich monopropellant based on ADN or HAN, and hydrogen peroxide.

7. The dual mode propulsion system of claim 5, comprising monopropellant rocket engines (40) and a liquid storable low-hazard fuel-rich monopropellant based on ADN or HAN, and hydrogen peroxide.

8. A spacecraft comprising the dual mode chemical rocket engine of claim 1.

9. A method of making a dual mode chemical rocket engine, comprising storing a fuel-rich ADN, or HAN based liquid monopropellant blend in a first separate tank of the dual mode chemical rocket engine of claim 1; and
storing highly concentrated hydrogen peroxide in a second separate tank.

10. A method of generating thrust, comprising injecting a fuel-rich liquid monopropellant into a flow of hot oxidizer-rich gas obtained from the decomposition of hydrogen peroxide, so that the fuel-rich liquid monopropellant thereby is decomposed and combusted along with the oxidizer-rich gas, wherein the fuel-rich liquid monopropellant is ADN, or HAN based.

11. The method of claim 10, wherein the thrust is generated in an engine of claim 1.

12. A spacecraft comprising the dual mode propulsion system of claim 5.

13. The dual mode chemical rocket engine of claim 4, wherein the secondary reaction chamber (150) is fabricated from rhenium lined with iridium.
